(19) United States
(12) Patent Application Publication
(10) Pub. No.: US 2005/0024495 A1
(43) Pub. Date: Feb. 3, 2005

(54) Infrared camera with slave monitor

(76) Inventors: Torbjorn Hamrelius, Sollentuna (SE); Tomas Lannestedt, Alvsjo (SE); Lars Heimer, Alunda (SE); Jan Lewerentz, Sollentuna (SE)

Correspondence Address: YOUNG & THOMPSON, 745 SOUTH 23RD STREET, 2ND FLOOR, ARLINGTON, VA, 22202, US

(21) Appl. No.: 10/491,240

(22) PCT Filed: Feb. 25, 2003
(86) PCT No.: PCT/SE03/00307

(30) Foreign Application Priority Data
Mar. 1, 2002 (SE) 0200629-4

(51) Int. Cl. H04M 1/00; H04N 7/18

(52) U.S. Cl. 348/149; 455/41.2

(57) ABSTRACT

An infrared (IR) camera includes a camera unit for recording IR images, a slave monitor connected to the camera unit for displaying IR images recorded by the camera unit. In this way, the camera unit can be moved independently of the operator. The slave monitor is preferably connected to the camera unit via a cable, a short-range radio connection or a Wireless LAN (WLAN) link. The connection is used for communicating image data from the camera unit to the slave monitor as they are recorded. The connection may also be used for control data from the slave monitor to the camera unit.

### TECHNICAL FIELD

The present invention relates to an Infrared (IR) camera as defined in the preamble of claim 1.

### BACKGROUND AND PRIOR ART

Infrared (IR) cameras are often used for inspecting machinery, electrical equipment for determining their temperature. Since the data collected by such cameras depend on the temperature of the imaged object, they are used to determine if an object has reached a temperature indicating danger or damage.

Such inspections often involve imaging in places that are hard to access, such as high up, underneath a machine or a piece of furniture, or around corners, so that the operator is forced to stretch or bend or assume another uncomfortable or risky position. For example, there is a risk of colliding with a sharp edge or a high-voltage component while looking in the camera's viewfinder.

### OBJECT OF THE INVENTION

It is an object of the present invention to facilitate IR imaging in places that are difficult to access.

### SUMMARY OF THE INVENTION

This object is achieved according to the invention by an An infrared (IR) camera comprising a camera unit for recording IR images said IR camera being characterized in that it comprises a slave monitor connected to the camera unit for displaying IR images recorded by the camera unit.

In this way, the camera unit can be moved independently of the operator. The operator can see what is being recorded by the camera even when the camera is used in inaccessible places, without having to stretch, bend or assume another uncomfortable position. It also eliminates risks that arise, for example when the operator works close to high-voltage electrical equipment, since the operator can see the surrounding environment better when he does not have to look into the viewfinder.

With the camera according to the invention, the operator can easily show another person the image while looking himself. The camera can be used outside in direct sunlight. It may also be placed on a tripod or other type of stand while the slave monitor is placed in a more accessible position.

The slave monitor is preferably connected to the camera unit by means of a cable, a short-range radio connection or a Wireless LAN (WLAN) link. The connection is used for communicating image data from the camera unit to the slave monitor as they are recorded. The connection may also be used for control data from the slave monitor to the camera unit. In the latter case, the slave monitor comprises at least one command entry means enabling the operator to control the operation of the camera unit.

If a WLAN connection is used, this enables the camera to become part of a computer network. The computers can then read from the camera's harddisk. Commands can be transmitted from the computers to the camera through the WLAN connection to enable more sophisticated control of the camera.

The slave monitor is preferably detatchably mounted on the camera unit, so that when it is not used it can be attached to the camera unit for easy transportation.

Preferably, the camera unit also comprises at least one display. This enables the camera to be used in the conventional way, when this is feasible. The camera unit and/or slave monitor should comprise functions for selecting which displays are to be used at any given time. This can be controlled using the control input means provided on the camera unit and slave monitor, such as control buttons and or joystick.

### BRIEF DESCRIPTION OF THE DRAWINGS

The present invention will be described in more detail in the following, with reference to the appended drawings, in which:

FIG. 1 shows a basic embodiment of the invention using a wired connection between the camera unit and the slave monitor;

FIG. 2 shows a basic embodiment of the invention using a wireless connection between the camera unit and the slave monitor;

FIG. 3 shows a preferred embodiment the IR camera with the slave monitor detached, seen from one side;

FIG. 4 shows the preferred embodiment of the IR camera with the slave monitor attached, seen from the other side;

FIG. 5 is a block diagram of the IR camera and slave monitor using a WLAN connection between them;

FIG. 6 is a block diagram of the IR camera and slave monitor using a WLAN connection between them;

FIG. 7 is a detailed schematic block diagram of an embodiment of the IR camera and slave monitor;

FIG. 8 is a detailed block diagram of the camera and slave monitor according to an embodiment of the invention.

FIG. 9A illustrates a possible solution for attaching the slave monitor to the camera unit.

FIG. 9B is an enlarged view of a part of the solution shown in FIG. 9A.

### DETAILED DESCRIPTION OF EMBODIMENTS

FIG. 1 shows a basic configuration of an IR camera according to the invention. The camera comprises a camera unit 1 and a slave monitor 3. The camera unit 1 comprises the functions necessary for registering IR images. The gathering of data and the data processing performed prior to displaying the image are carried out in the conventional way. This technology is known to the skilled person, but will be briefly discussed in the following. The radiation is focused by at least one lens 5 onto a detector array 7. The detector array is typically a matrix of detectors, each detecting radiation from a corresponding area on the body being imaged. From the detector array the signal is fed to a signal conditioning unit 9 which performs conventional signal conditioning such as corrections for the inherent offset and gain drift. From the signal conditioning unit 9 the image may be sent to the slave monitor through a cable 11, to be displayed on the display 13 of the slave monitor 3. Preferably, the cable 11 is detachable from the camera unit 1.

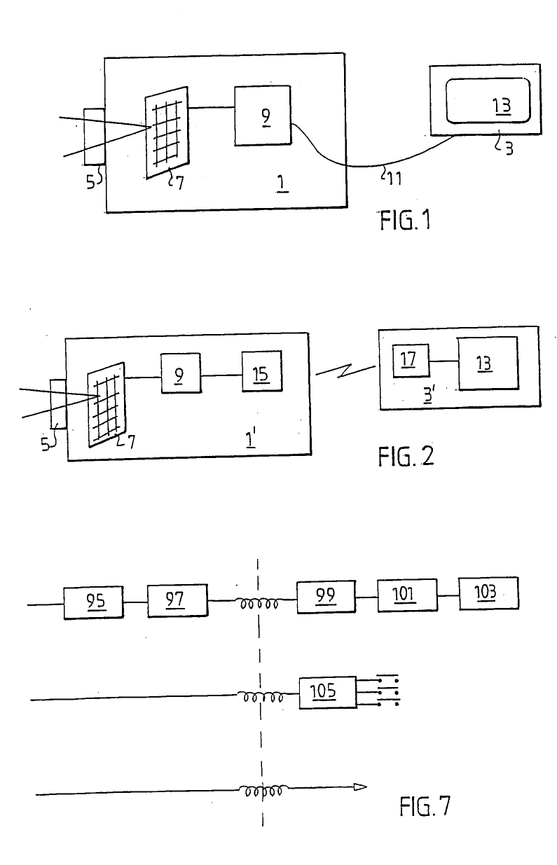

FIG. 2 shows a basic configuration of an IR camera according to the invention. The camera comprises a camera unit 1′ and a slave monitor 3′. The camera unit 1′ comprises the functions necessary for registering IR images. The gathering of data and the data processing performed prior to displaying the image are carried out as briefly discussed in connection with FIG. 1. In this embodiment the camera unit 1′ and the slave monitor 3 comprise means 15 and 17, respectively, for wireless communication. These means may be short-range radio transmitters having sufficient bandwidth. For transmitting commands between the camera unit and the slave monitor a bandwidth of 1 kbit/s will be sufficient. For transmitting images a higher bandwidth will be necessary. Of course, the bandwidth requirements may be reduced by means of compression, for example if IEEE 802, having a bandwidth of 11 Mbit/s is used.

The transmitting range usually does not have to be great, usually less than two meters, since the camera unit and the slave monitor will usually be operated by the same person. Thus, the range of a radio link (up to 10 meters) will usually be sufficient. The Bluetooth standard may be used for communication between the camera unit and the slave monitor. A WLAN connection also has a greater range than necessary. A WLAN connection is always bidirectional thus enabling communication both from the camera unit to the slave monitor and vice versa. When radio link connection is used, an additional transmitter must be used in the slave monitor for transmitting commands from the slave monitor to the camera unit. Alternatively, communication may be made unidirectional. In this case images and possibly commands are sent from the camera unit to the slave monitor, but the camera unit cannot be controlled from the slave monitor.

All the described transmitters fulfil the common requirement that the maximum output power should be 10 mW.

The wireless communication means of the camera unit is connected to, and receives data from, the signal conditioning unit 9. This data is transmitted to the wireless communication means of the slave monitor. The image is displayed on the display of the slave monitor.

The configurations shown in FIGS. 1 and 2 are simplified, to focus on the main aspects of the invention. In both these configurations the slave monitor may comprise control input means, such as control buttons, for controlling the function of the camera. This will be discussed in more detail in the following.

In any embodiment, the functions may be divided between the camera unit and the slave monitor in any way that is found feasible. To keep the display part as small and light as possible, however, as many functions as possible should be implemented in the camera unit. Usually the camera unit will also comprise at least a viewfinder, but it may also comprise another display unit.

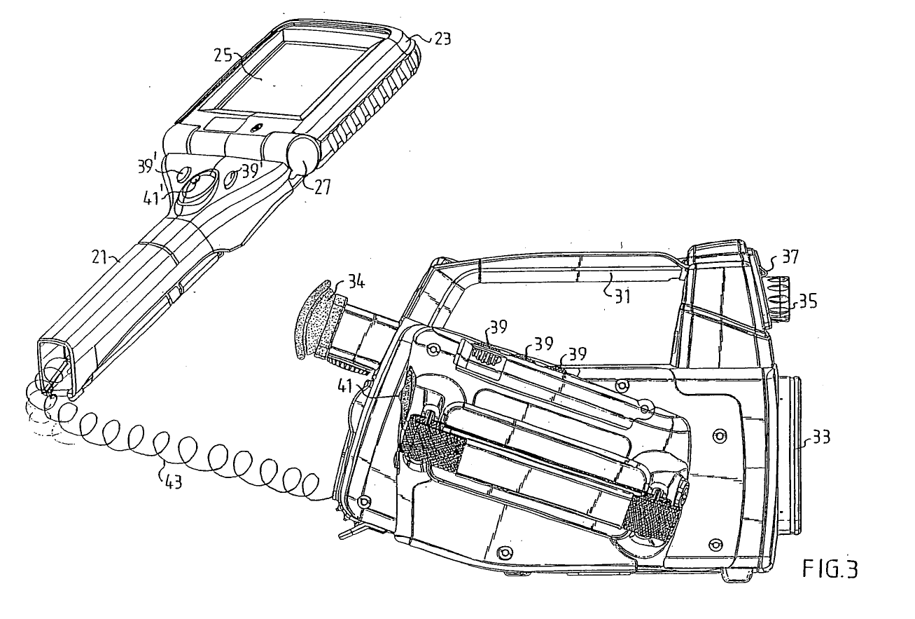

FIG. 3 is a right-hand view of the camera according to a concrete embodiment of the invention, with the slave monitor 3 detached from the camera unit 1. The slave monitor comprises a handle 21 and a display part 23, comprising a display 25. The handle and the display part are joined together at a joint 27, which enables the display part 23 to be placed at an angle relative to the handle 21. This enables ergonomic use of the slave monitor by different people and in different situations.

As can be seen, the camera unit comprises a handle 31, making the camera easy to hold. The handle is shaped in such away that it can receive a part of the slave monitor, however, FIG. 3 shows the slave monitor detached from the camera unit. The handle is shaped in such a way that it can be held comfortably both when the slave monitor is attached and when the slave monitor is not attached to the camera unit.

The camera comprises an IR lens 33 for registering thermal data and IR imaging functions (not shown). As is common in the art a viewfinder 34 on the camera unit may be used for aiming the camera and watching the registered image. In this particular embodiment, in addition to the IR imaging functions, the camera unit also comprises a video lens 35 and video imaging functions (not shown). The camera unit also comprises a laser pointer 37 for emitting a laser beam to assist in aiming.

In this particular embodiment, the camera unit also comprises three control wheels 39 and a joystick 41 used for adjustment and control.

FIG. 3 shows a wired connection 43 between the camera unit and the slave monitor. Preferably a coiled wire is used, to provide maximum freedom of movement. As mentioned above, the connection may also be wireless, if the camera unit and the slave monitor comprise functions for wireless communication, as discussed in connection with FIG. 2.

When the slave monitor is attached to the camera unit, as well as when it is detached the operator may watch the image on the display 25 of the slave monitor 3 and use control buttons 39′ and joystick 41′ provided on the slave monitor to control the camera. The commands registered by the control buttons 39, 39′ and joysticks 41, 41′ are transmitted to the camera unit by a data bus referred to as the Smart Management Bus (SMBus).

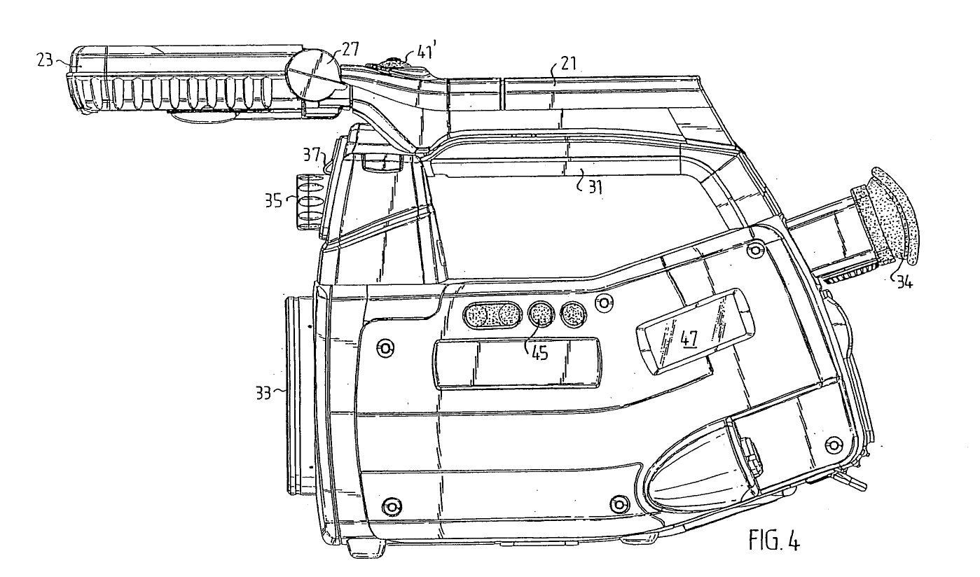

FIG. 4 is a left-hand view of the camera according to the same concrete embodiment as shown in FIG. 3, with the slave monitor 3 attached to the camera unit 1. For details about how the slave monitor may be attached to the camera unit, see the discussion of FIG. 5.

The Figure also shows a number of programmable control buttons 45 and a status Liquid Crystal Display (LCD) 47. They are not associated with the inventive functions and will not be described in further detail here.

The slave monitor also comprises two control buttons and a joystick for adjustment and control. Also there is a Light-Emitting Diode (LED) indicating that the camera and/or the slave monitor is on. The LED can also have different colours to indicate different functions, such as loading. The control is preferably menu driven.

FIG. 5 is a block diagram of the parts connecting the camera and the slave monitor when a WLAN connection is used between the two. The WLAN connection is according to the WLAN radio standard, IEEE 802.11B. In the camera unit, a video encoder 51 receives the image input either from the IR camera or from the video imaging function if included. The image signals complly with the standard CCIR/ITU 601-2/656 (4-2-2 video). The video encoder block 51 encodes the image and forwards it to a camera WLAN adapter block 53, comprising a wireless transmit/receive function indicated by an antenna 55. A button decoder 57 receives command input from the camera WLAN adapter block 53 in dependence of commands entered by an operator by means of buttons and/or joystick or other input means on the slave monitor and transmitted to the WLAN adapter. The commands are forwarded to control logic in the camera unit on the Smart Management Bus (SMBus)

In the slave monitor part a similar slave WLAN adapter block 59 having a similar transmit/receive function indicated by an antenna 61 communicates with the camera WLAN adapter 55. The slave WLAN adapter block 59 is connected to a video decoder 63 which receives the image signals received from the camera WLAN adapter block, decodes them and forwards them to the display 65 of the slave monitor. The slave WLAN adapter block 59 is also connected to a button encoder block 67. The button encoder block receives command inputs entered by the operator by means of buttons and/or other input means on the slave monitor, encodes the commands and forwards them to the slave WLAN adapter block 59. The slave WLAN adapter block 59 in turn transmits the encoded command signals to the camera WLAN adapter block 53.

The camera unit has a battery system (not shown) and the slave monitor has a battery 69. To co-ordinate the power system of the camera unit and the slave monitor, the camera has a camera power synchronizer 71 and the slave monitor has a slave power synchronizer 73. When the slave monitor is attached to the camera unit the power synchronizers 71, 73 are interconnected by means of connectors 75. When interconnected, the camera unit and the slave monitor unit share a common battery capacity. The battery and battery unit may be charges simultaneously when interconnected.

When the camera unit and slave monitor are connected by means of a wireless connection, such as WLAN or radio link a control unit is needed on each side to control the stages of power supply, such as charging, equalization between the battery and the battery system, when the slave monitor is attached to the camera unit and when it is released from the camera unit. The synchronization units 71, 73 should control how to recover from sleep mode.

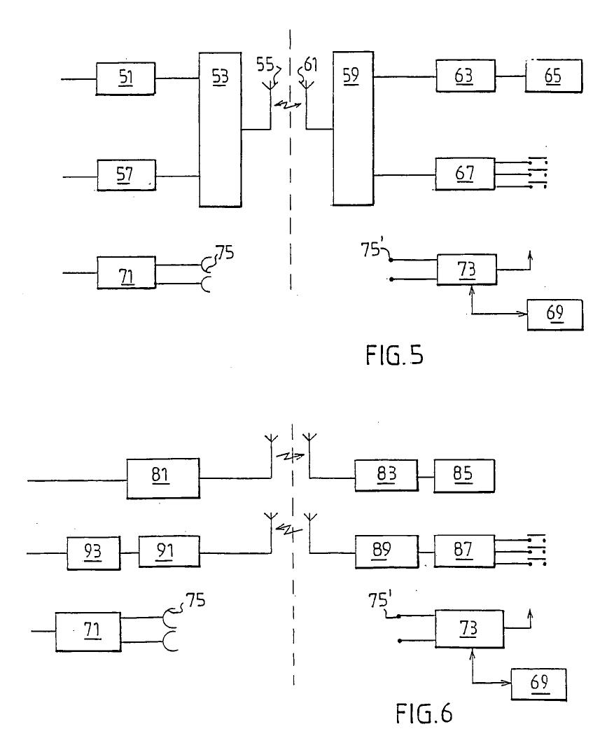

FIG. 6 is a block diagram of the parts connecting the camera and the slave monitor when a radio link connection is used between the two. The battery and power synchronization blocks 69, 71, 73, 75, 75′ are the same as in FIG. 5. When a wired connection is used these units are not needed.

When a radio link connection is used, as shown in FIG. 6, a camera transmitter unit 81 receives IR image input or video image input from the relevant imaging unit (not shown). SMPTE 170M NTSC or ITU-R BT.470 PAL is used for the image signal to the camera transmitter. The signal transmitted on the radio link by the camera transmitter is received by a slave receiver 83 in the slave monitor. From the slave receiver 83 the image is forwarded to the display 85 where it is displayed to the operator.

In the slave monitor there is a button encoder 87 arranged to receive control input entered on the slave monitor by the operator by means of buttons or joystick or other input means. The button encoder 87 encodes the commands and forwards them to a slave transmitter 89 which transmits the commands over a radio link to a camera receiver 91. From the camera receiver 91 the commands are forwarded to a button decoder 93 and transferred to control logic in the camera unit by means of an SMBus.

In any of the embodiments shown, the slave monitor and/or the camera unit may also comprise a built-in microphone for registering sound. If the slave monitor comprises a microphone the sound data must be transferred to the camera unit for storing and/or processing.

FIG. 7 is a is a block diagram of the parts connecting the camera and the slave monitor when a wired connection is used between the two. The wired connection is used to transmit image signals, control data and power. The battery and power synchronization blocks shown in FIGS. 5 and 6 are not needed when a wired connection is used.

A video encoder 95 in the camera unit receives the image signal on the CCIR/ITU 601-2/656 (4-2-2 video) format encodes it and forwards it to a wire driver 97. The wire driver is connected, via a Low Voltage Differential Signalling (LVDS) connection to a wire receiver 99 in the slave monitor. A video decoder 101 in the slave monitor receives the encoded image signal from the wire receiver 99, deocdes it and forwards it to the display 103, on which it is displayed to the operator.

An SMBus Input/Output unit 105 receives commands entered on the slave monitor by the operator and forwards them in the opposite direction using the LVDS connection.

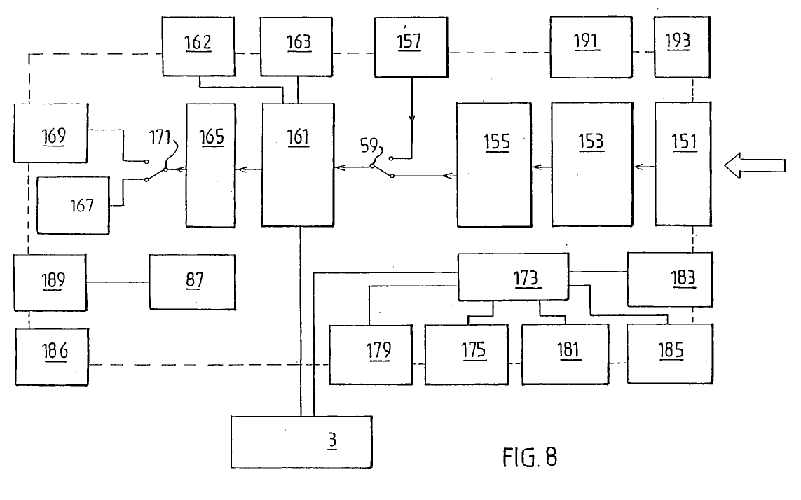

FIG. 8 is a detailed block diagram of the camera and slave monitor according to an embodiment of the invention. The camera part comprises infrared optics 151 for registering thermal radiation from an object. The image registered by the infrared optics is fed to an image correction and compensation system 153 and from there to a temperature calibration and measurement system 155. The camera part also comprises a visual camera block 157.

Switch logic 159 controls the input to an image presentation system 161 from either the infrared optics 151 through the blocks 153 and 155, or from the visual camera 157. The image input to the image presentation system 161 can be viewed by the operator in a viewfinder 163 and/or stored by an image storage system block 165 either in a fixed internal storage medium 167 or a removable storage medium 169.

The selection of storage medium 167, 169 is controlled by switch logic 171. The data from the visual camera 157 may also be output from the image presentation system 161 through a video output connector 162.

The camera part also comprises a control block 173 for system control and communication. This control block is arranged to receive control input from a joystick and one or more control buttons 175. One or more programmable buttons 179 may also be provided, to communicate with the control block 173 for control functions adapted to the user's needs. A headset connection 181 may also be provided on the camera for recording of sound, which will be controlled by the control block 173. Other communication ports such as an IRDA port 183 for infrared wireless communication and a USB port 185 for wired communication may also be controlled by the control block. Sound is recorded by an external microphone (not shown) connected to a connector on the camera using the 12S standard to provide a raw uncompressed sound signal. The sound signal can be compressed to MPG3 and stored in the file system of the camera or added to the Digital Video (DV) circuit and transmitted along with the image according to the DV format on the high speed PC link output 86 according to IEEE 1394 (commonly referred to as FireWire). Alternatively, the sound file may be stored in association with one or more image files.

The slave monitor receives image data from the image presentation system 161, including control information such as image synchronization pulses. Information concerning the communication may be embedded in the image stream, in particular when WLAN or wired connection is used. If a radio link is used separate logic is needed to handle such information. The control block 173 also receives control information entered by the operator by means of the control buttons and joystick comprised in the slave monitor (see FIG. 4).

The camera part also comprises a power system 187, including a battery, providing power to the camera through a power input connector 189. An LCD 191 for presentation of system status is also included as well as a laser pointer 193.

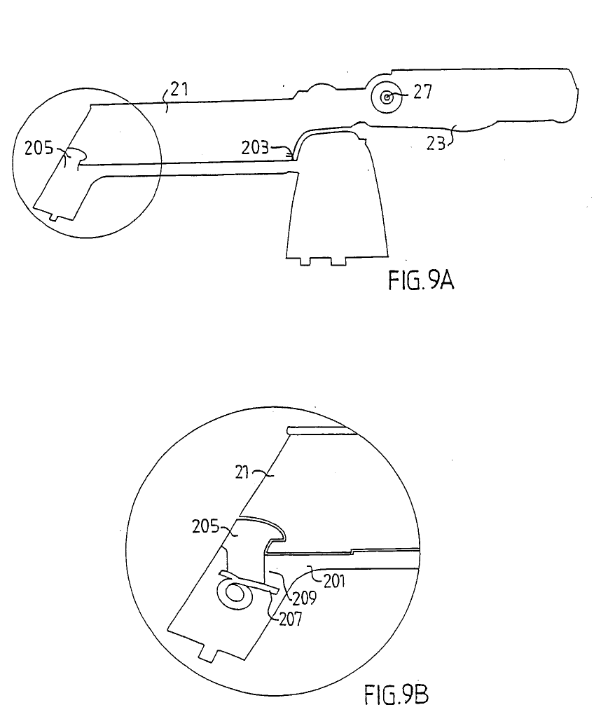

FIG. 9A illustrates one method of attaching the slave monitor to the camera part. FIG. 9B is an enlarged view of the portion within the circle in FIG. 9A. In this embodiment, the slave monitor is designed essentially as shown in FIG. 3, with a slave monitor handle 21 holding a display part 23. The camera unit 1 comprises a camera unit handle 201 with a groove for receiving the slave monitor handle 21. At the front end of the groove there is a first shoulder 203 for co-operating with a first recess in the slave monitor handle 21 near the joint 27 between the slave monitor handle 21 and the display 23 when the slave monitor is attached to the camera unit. At the rear end of the groove there is a second shoulder 205. The second shoulder 205 is spring loaded by a coil spring 207 and is arranged to interact with a second recess on the slave monitor handle to hold the slave monitor in place when attached to the camera unit handle. A fixed portion 209 of the camera unit handle 201 stops the second shoulder in the appropriate position for holding the slave monitor handle 21.

In this way, quick release of the slave monitor is achieved simply by pressing it backwards until it avoids the first shoulder and lifting it up clear of the second shoulder. The slave monitor can be attached to the camera unit handle by sliding it into the groove on the camera unit handle, moving it backwards until the second shoulder is slightly displaced and releasing it so that the first shoulder co-operates with the first recess.

The person skilled in the art will appreciate that a number of different mechanical means for attaching the slave monitor in a detachable way are conceivable.

The camera also preferably comprises other communication means, such as an IRDA port for IR communication with standard devices such as personal computers or personal digital assistants, a headset connector for connecting a headset and a Universal Serial Bus (USB) connector for communication with a personal computer or other standard device.

1. An infrared (IR) camera comprising a camera unit (1; 1′) for recording IR im-ages, said IR camera being characterized in that it comprises a slave monitor (3; 3′) connected to the camera unit (1; 1′) for displaying IR images recorded by the camera unit, wherein the slave monitor (3; 3′) is detachably mounted to the cam-era unit (1; 1′) and comprises control input means (39′, 41′) for providing con-trol signals to the camera unit in dependence of operator input.

2. An IR camera according to claim 1, wherein the camera unit (1; 1′) and the slave monitor (3; 3′) comprise wireless communication means (15, 17; 53, 55, 59, 61; 81, 83, 89, 91) for communicating wirelessly with each other.

3. An IR camera according to claim 2, wherein the wireless communication means (53, 55, 59, 61) provide a WLAN connection between the camera unit (1; 1′) and the slave monitor (3; 3′).

4. An IR camera according to claim 2, wherein the wireless communication means (81. 83. 89. 91) provide a radio link connection between the camera unit (1; 1′) and the slave monitor (3;3′).

5. An IR camera according to claim 1, wherein the camera unit (1; 1′) and the slave monitor (3; 3′) communicate with each other through a wired connection.

6. An IR camera according to claim 1, wherein the slave monitor (3; 3′) comprises means (39′, 41′) for turning the display (25) on the slave monitor on and off.

7. An IR camera according to claim 1, wherein the slave monitor comprises a handle (21) and a display part (23), said display part comprising a display (25).

8. An IR camera according to claim 7, wherein the handle (21) and the display part (23) are joined together by a joint (27), which enables the display part (23) to be placed at an angle relative to the handle (21).

9-10. (canceled)
